(19) United States
(12) Patent Application Publication
(10) Pub. No.: US 2013/0286902 A1
(43) Pub. Date: Oct. 31, 2013

(54) FLEXIBLE SPECIAL SUBFRAME CONFIGURATION FOR TDD IN LTE

(71) Applicant: QUALCOMM Incorporated, San Diego, CA (US)

(72) Inventors: Wanshi Chen, San Diego, CA (US); Hao Xu, San Diego, CA (US); Youngbin Wei, San Diego, CA (US)

(21) Appl. No.: 13/840,397

(22) Filed: Mar. 15, 2013

Related U.S. Application Data
(60) Provisional application No. 61/639,685, filed on Apr. 27, 2012.

(51) Int. Cl. H04W 24/02

(52) U.S. Cl. CPC H04W 24/02
USPC 370/280

(57) ABSTRACT

Dynamically changing uplink-downlink configurations in adjacent cells in a TDD networks introduces interference to special subframes between downlink and uplink transmissions. Adaptation is disclosed of different special subframe configurations for certain subframes based on different communication environment characteristics experienced on the special subframes. The different special subframe configurations may be differ among special subframe within the same or in a different radio frames or may be applied to a corresponding subframe in a neighboring cell. Over time, as changes to the communication environment are detected, the special subframe configurations may adapt to the communication environment characteristics.

### CROSS-REFERENCE TO RELATED APPLICATIONS

This application claims the benefit of U.S. Provisional Patent Application No. 61/639,685, entitled, “FLEXIBLE SPECIAL SUBFRAME CONFIGURATION FOR TDD IN LTE”, filed on Apr. 27, 2012, which is expressly incorporated by reference herein in its entirety.

### BACKGROUND

1. Field

Aspects of the present disclosure relate generally to wireless communication systems, and more particularly, to a flexible special subframe configuration for time division duplex (TDD) in Long Term Evolution (LTE) communication systems.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

Various aspects of the present disclosure are directed to allowing use of different configurations on certain subframes in radio transmissions. Dynamically changing uplink-downlink configurations in adjacent cells in a TDD networks introduces interference to special subframes between downlink and uplink transmissions. Different special subframe configurations are adapted for certain subframes based on different communication environment characteristics experienced on the special subframes. The different special subframe configurations may be differ among special subframe within the same or in a different radio frames or may be applied to a corresponding subframe in a neighboring cell. Over time, as changes in the communication environment are detected, the special subframe configurations may adapt to the communication environment characteristics.

Representative aspects of the present disclosure are related to a method of wireless communication that includes determining, by a user equipment (UE), a first configuration for a first special subframe in a radio transmission in a frame and determining, by the UE, a second configuration for a second subframe in the frame, wherein the first configuration is different than the second configuration and the second configuration comprises at least a guard period (GP).

Additional representative aspects of the present disclosure are related to a method of wireless communication that includes determining, at a base station, a first configuration for a first special subframe in a radio transmission in a frame, detecting, by the base station, a difference between an interference level experienced by a second subframe in the frame relative to a prior frame, and detecting, by the base station, a second configuration for the second subframe in response to the detected difference, wherein the first configuration is different than the second configuration and the second configuration comprises at least a GP.

Further representative aspects of the present disclosure relate to an apparatus configured for wireless communication that includes means for determining, by a UE, a first configuration for a first special subframe in a radio transmission in a frame and means for determining, by the UE, a second configuration for a second subframe in the frame, wherein the first configuration is different than the second configuration and the second configuration comprises at least a GP.

Further representative aspects of the present disclosure relate to an apparatus configured for wireless communication that includes means for determining, at a base station, a first configuration for a first special subframe in a radio transmission in a frame, means for detecting, by the base station, a difference between an interference level experienced by a second subframe in the frame relative to a prior frame, and means for detecting, by the base station, a second configuration for the second subframe in response to the detected difference, wherein the first configuration is different than the second configuration and the second configuration comprises at least a GP.

Further representative aspects of the present disclosure are directed to a computer program product for wireless communications in a wireless network that includes a non-transitory computer-readable medium having program code recorded thereon. The program code includes code for causing a computer to determine, by a UE, a first configuration for a first special subframe in a radio transmission in a frame and code for causing a computer to determine, by the UE, a second configuration for a second subframe in the frame, wherein the first configuration is different than the second configuration and the second configuration comprises at least a GP.

Further representative aspects of the present disclosure are directed to a computer program product for wireless communications in a wireless network that includes a non-transitory computer-readable medium having program code recorded thereon. The program code includes code for causing a computer to determine, at a base station, a first configuration for a first special subframe in a radio transmission in a frame, code for causing a computer to detect, by the base station, a difference between an interference level experienced by a second subframe in the frame relative to a prior frame, and code for causing a computer to detect, by the base station, a second configuration for the second subframe in response to the detected difference, wherein the first configuration is different than the second configuration and the second configuration comprises at least a GP.

Further representative aspects of the present disclosure relate to an apparatus configured for wireless communication that includes at least one processor and a memory coupled to the processor. The processor is configured to determine, by a UE, a first configuration for a first special subframe in a radio transmission in a frame and to determine, by the UE, a second configuration for a second subframe in the frame, wherein the first configuration is different than the second configuration and the second configuration comprises at least a GP.

Still further representative aspects of the present disclosure relate to an apparatus configured for wireless communication that includes at least one processor and a memory coupled to the processor. The processor is configured to determine, at a base station, a first configuration for a first special subframe in a radio transmission in a frame, to detect, by the base station, a difference between an interference level experienced by a second subframe in the frame relative to a prior frame, and to detect, by the base station, a second configuration for the second subframe in response to the detected difference, wherein the first configuration is different than the second configuration and the second configuration comprises at least a GP.

### BRIEF DESCRIPTION OF THE DRAWINGS

FIG. 1 is a block diagram conceptually illustrating an example of a mobile communication system.

FIG. 2 is a block diagram conceptually illustrating an example of a downlink frame structure in a mobile communication system.

FIG. 3 is a block diagram conceptually illustrating a design of a base station/eNB and a UE configured according to one aspect of the present disclosure.

FIG. 4 shows an exemplary frame structure for TDD in LTE.

FIGS. 5A and 5B are diagrams illustrating example TDD radio frame transmissions.

FIGS. 6A and 6B are diagrams illustrating radio frame transmissions configured according to one aspect of the present disclosure.

FIGS. 7A and 7B are functional block diagrams illustrating example blocks executed to implement one aspect of the present disclosure.

FIG. 8 is a block diagram illustrating radio frame transmissions configured according to one aspect of the present disclosure.

FIG. 9 is a block diagram illustrating radio frame transmissions configured according to one aspect of the present disclosure.

FIG. 10 is a block diagram illustrating a UE configured according to one aspect of the present disclosure.

FIG. 11 is a block diagram illustrating an eNB configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

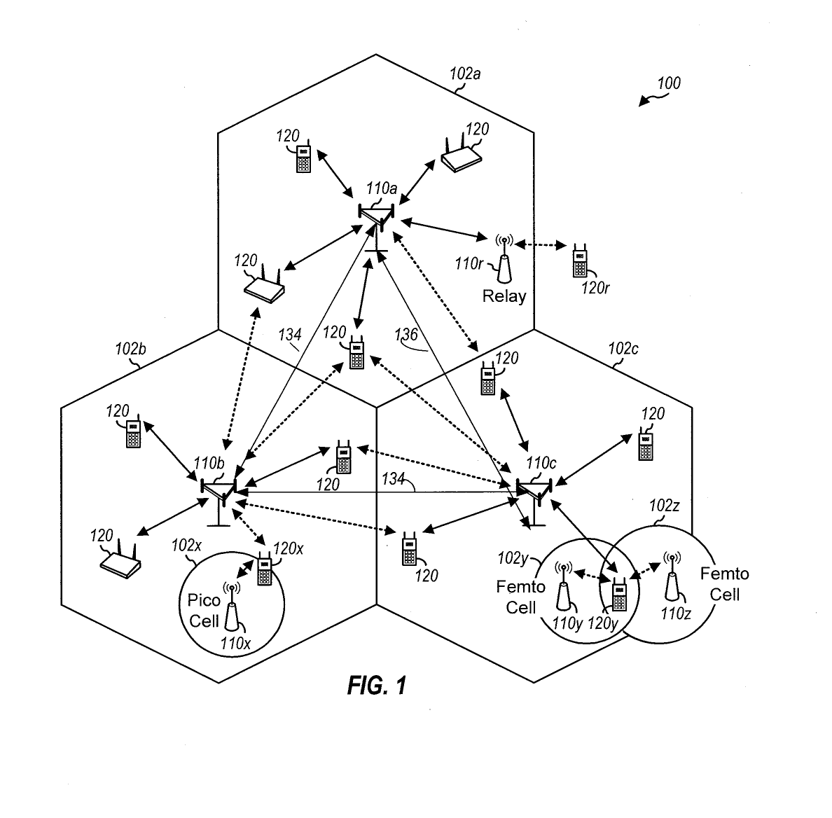

FIG. 1 shows a wireless network 100 for communication, which may be an LTE-A network. The wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the eNBs 110a, 110b and 110c are macro eNBs for the macro cells 102a, 102b and 102c, respectively. The eNB 110x is a pico eNB for a pico cell 102x. And, the eNBs 110y and 110z are femto eNBs for the femto cells 102y and 102z, respectively. An eNB may support one or multiple (e.g., two, three, four, and the like) cells.

The wireless network 100 also includes a relay station 110r which may communicate with the eNB 110a and a UE 120r. A relay station may also be referred to as a relay eNB, a relay, and the like.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 72, 180, 300, 600, 900, and 1200 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

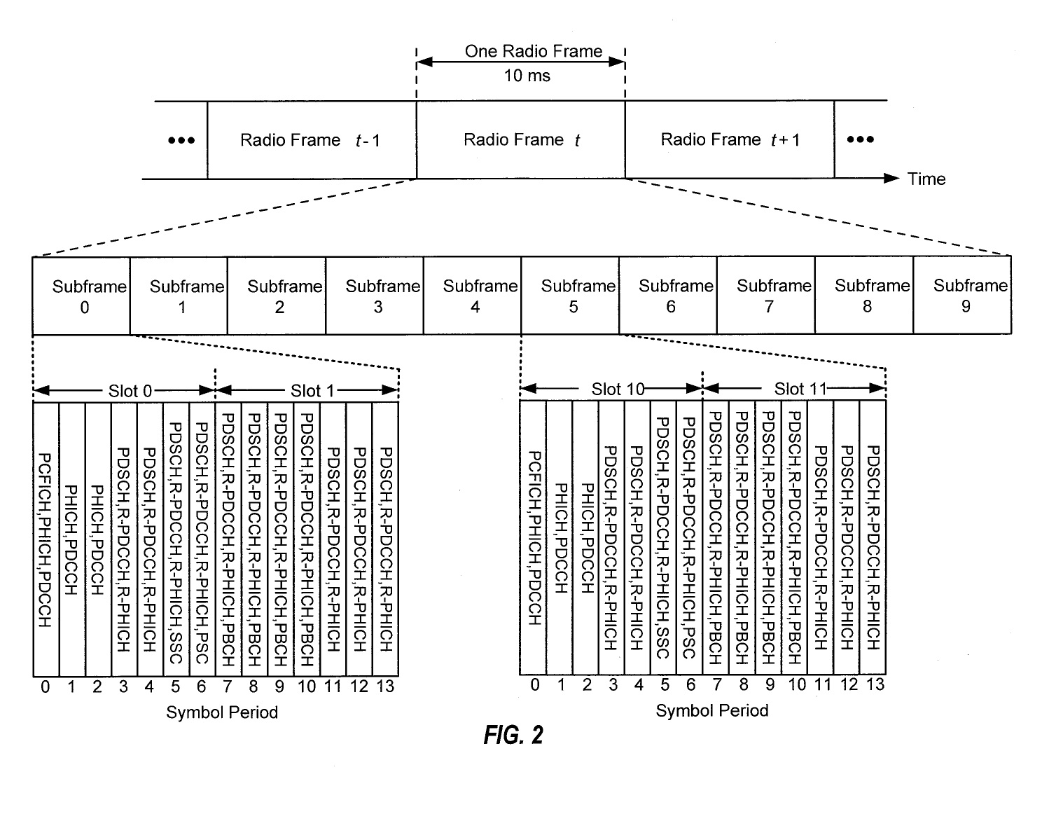

FIG. 2 shows a downlink frame structure used in LTE/-A. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE/-A, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as seen in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 2. The PHICH may carry information to support hybrid automatic retransmission (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

In addition to sending PHICH and PDCCH in the control section of each subframe, i.e., the first symbol period of each subframe, the LTE-A may also transmit these control-oriented channels in the data portions of each subframe as well. As shown in FIG. 2, these new control designs utilizing the data region, e.g., the Relay-Physical Downlink Control Channel (R-PDCCH) and Relay-Physical HARQ Indicator Channel (R-PHICH) are included in the later symbol periods of each subframe. The R-PDCCH is a new type of control channel utilizing the data region originally developed in the context of half-duplex relay operation. Different from legacy PDCCH and PHICH, which occupy the first several control symbols in one subframe, R-PDCCH and R-PHICH are mapped to resource elements (REs) originally designated as the data region. The new control channel may be in the form of Frequency Division Multiplexing (FDM), Time Division Multiplexing (TDM), or a combination of FDM and TDM.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

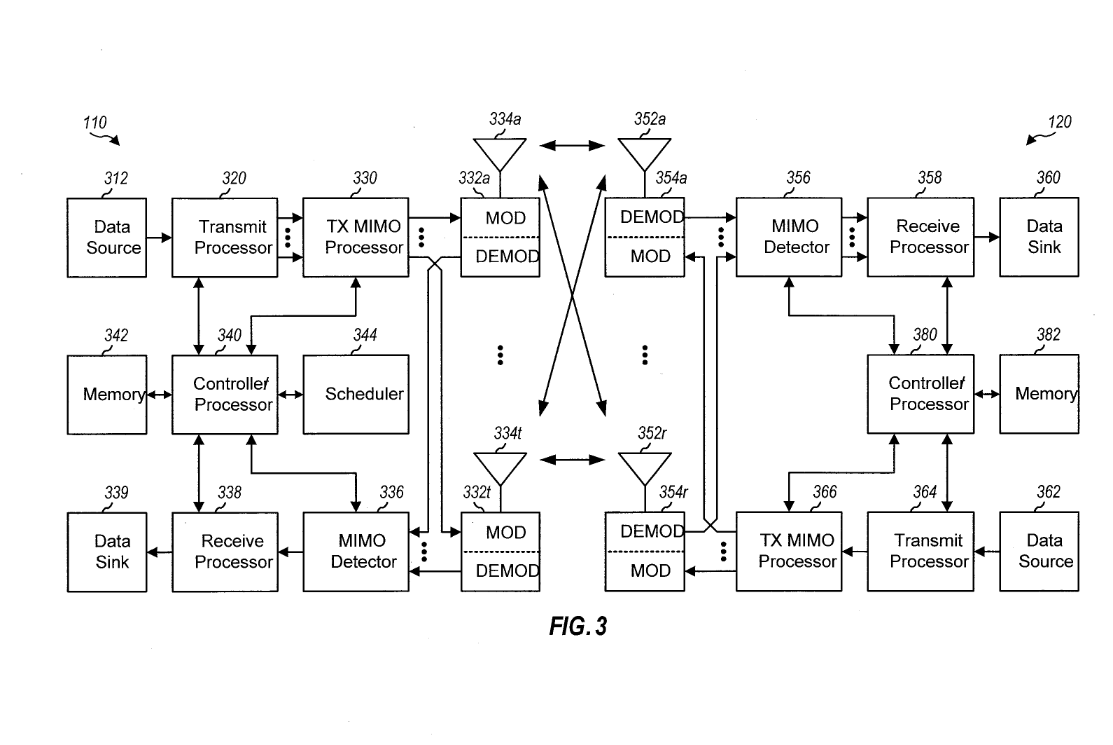

FIG. 3 shows a block diagram of a design of a base station/eNB 110 and a UE 120, which may be one of the base stations/eNBs and one of the UEs in FIG. 1. For a restricted association scenario, the eNB 110 may be the macro eNB 110c in FIG. 1, and the UE 120 may be the UE 120y. The eNB 110 may also be a base station of some other type. The eNB 110 may be equipped with antennas 334a through 334t, and the UE 120 may be equipped with antennas 352a through 352r.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the eNB 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the eNB 110. At the eNB 110, the uplink signals from the UE 120 may be received by the antennas 334, processed by the modulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

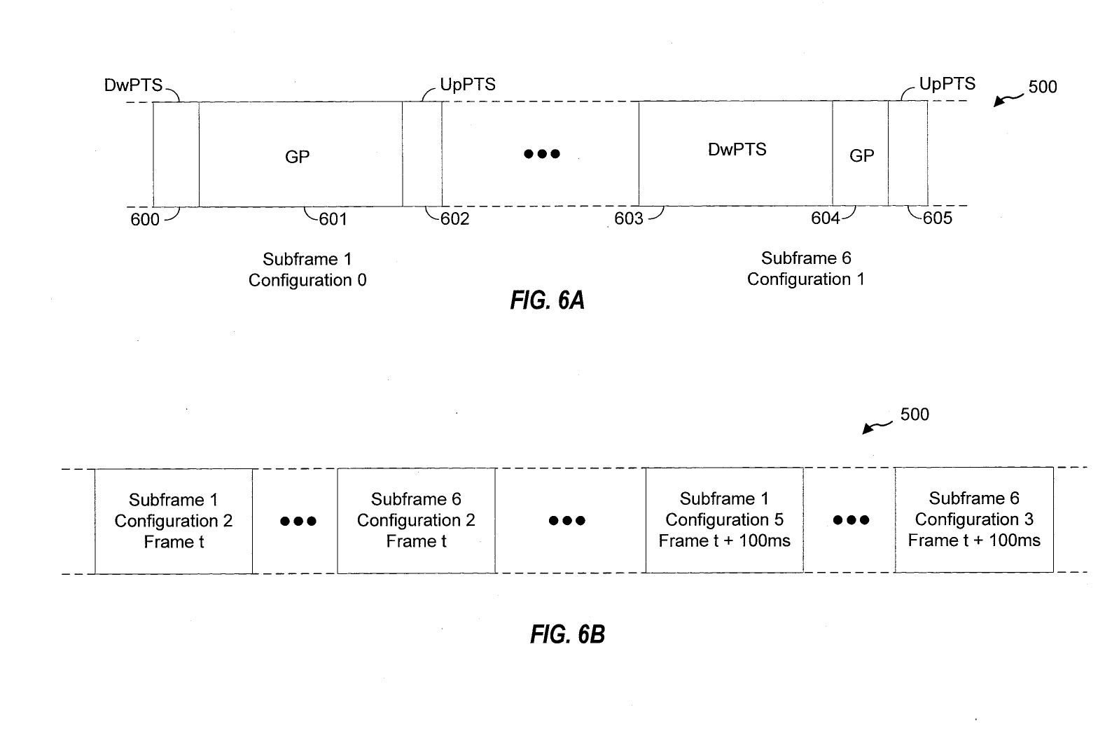

The controllers/processors 340 and 380 may direct the operation at the eNB 110 and the UE 120, respectively. The controller/processor 340 and/or other processors and modules at the eNB 110 may perform or direct the execution of various processes for the techniques described herein. The controllers/processor 380 and/or other processors and modules at the UE 120 may also perform or direct the execution of the functional blocks illustrated in FIG. 7, and/or other processes for the techniques described herein. The memories 342 and 382 may store data and program codes for the eNB 110 and the UE 120, respectively. A scheduler 344 may schedule UEs for data transmission on the downlink and/or uplink.

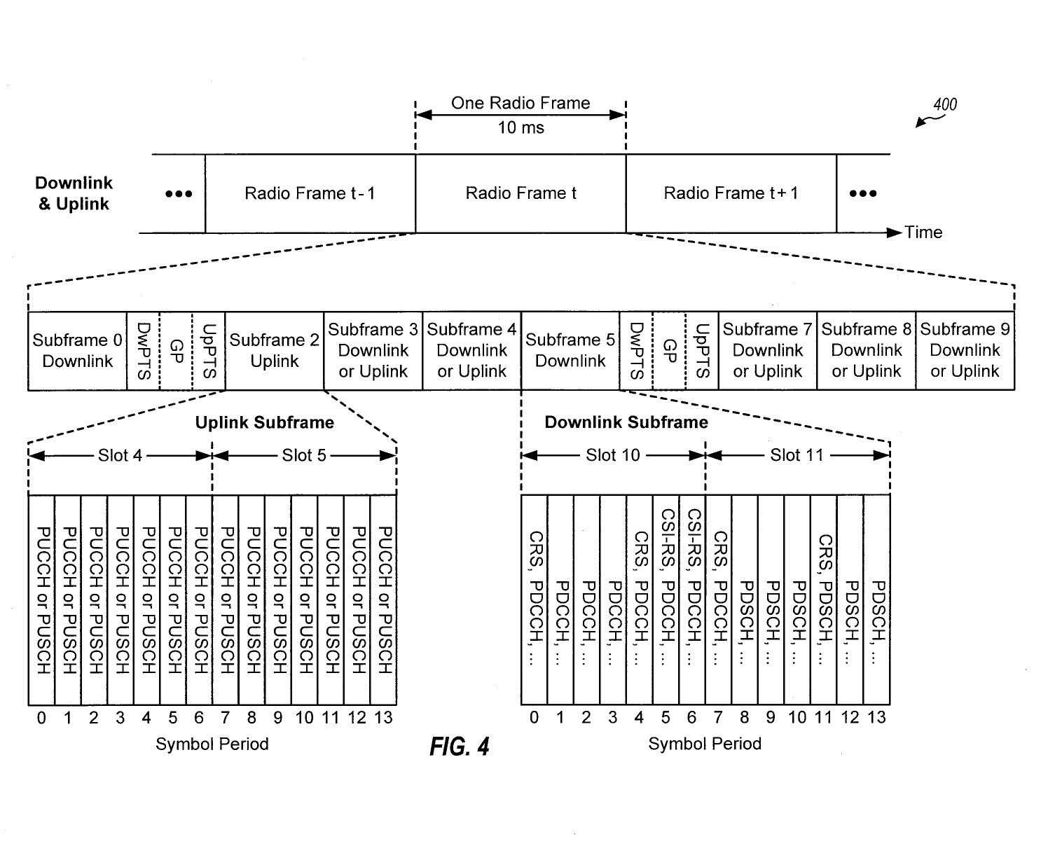

The LTE communications standard supports both FDD and TDD frame structures. FIG. 4 shows an exemplary frame structure 400 for TDD in LTE. The transmission timeline for the downlink and uplink may be partitioned into units of radio frames, and each radio frame may be partitioned into 10 subframes with indices of 0 through 9. LTE supports a number of uplink-downlink configurations for TDD. Subframes 0 and 5 are used for the downlink and subframe 2 is used for the uplink for all uplink-downlink configurations. Subframes 3, 4, 7, 8 and 9 may each be used for the downlink or uplink depending on the uplink-downlink configuration. Subframe 1, also known as a special subframe, includes three special fields composed of a Downlink Pilot Time Slot (DwPTS) used for downlink control channels as well as data transmission, a Guard Period (GP) of no transmission, and an Uplink Pilot Time Slot (UpPTS) used for either a random access channel (RACH) or sounding reference signals (SRS) or both. Subframe 6 may be a special subframe, or a downlink subframe depending on the uplink-downlink configuration. The DwPTS, GP and UpPTS may have different durations depending on special subframe configurations and other configurations (e.g., whether a normal cyclic prefix, CP, or an extended CP is configured for downlink and/or uplink). For TDD, each subframe used for the downlink may be referred to as a downlink subframe, and each subframe used for the uplink may be referred to as an uplink subframe.

Table 1 lists seven exemplary uplink-downlink configurations available in an LTE network supporting TDD operation. Each uplink-downlink configuration indicates whether each subframe is a downlink subframe (denoted as “D” in Table 1), or an uplink subframe (denoted as “U” in Table 1), or a special subframe (denoted as “S” in Table 1). As shown in Table 1, uplink-downlink configurations 1 through 5 have more downlink subframes than uplink subframes in each radio frame.

TABLE 1
LTE TDD DL/UL Subframe Configurations

| Uplink- | Downlink- | | | | | | | | | | |
|---|---|---|---|---|---|---|---|---|---|---|---|
| Downlink | to-Uplink | | | | | | | | | | |
| Config- | Switch-point | Subframe Number n | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Note that there are two switching periodicities, 5 ms and 10 ms, in the collection of subframe configurations. In the subframe configurations with a 5 ms periodicity, there are two special subframes in one frame (10 ms). In the subframe configurations with a 10 ms periodicity, there is one special subframe per frame. Each special subframe includes three parts: DwPTS, GP and UpPTS, where the division among the three parts are configurable. The supported special subframe configurations in LTE Rel-8/9/10 are identified in Table 2. In LTE Rel-11, one more special subframe is introduced for normal and extended cyclic prefix conditions, respectively. For DwPTS with normal cyclic prefix in downlink, special subframe configuration 9 is added for (DwPTS:GP:UpPTS)=(6:6:2) symbols. For DwPTS with extended cyclic prefix in downlink, special subframe configuration 7 is added (DwPTS:GP:UpPTS)=(5:5:2) symbols.

TABLE 2
LTE Rel-8/9/10 Special Subframe Configurations

| | Normal Cyclic Prefix in DL | | | Extended Cyclic Prefix in DL | | |
|---|---|---|---|---|---|---|
| Special | | UpPTS | | | UpPTS | |
| Subframe | | Normal | Extended | | Normal | Extended |
| Configuration | DwPTS | CP in UL | CP in UL | DwPTS | CP in UL | CP in UL |
| 0 | 6592 Tₛ | 2192 Tₛ | 2560 Tₛ | 7680 Tₛ | 2192 Tₛ | 2560 Tₛ |
| 1 | 19760 Tₛ | | | 20480 Tₛ | | |
| 2 | 21952 Tₛ | | | 23040 Tₛ | | |
| 3 | 24144 Tₛ | | | 25600 Tₛ | | |
| 4 | 26336 Tₛ | | | 7680 Tₛ | 4384 Tₛ | 5120 Tₛ |
| 5 | 6592 Tₛ | 4384 Tₛ | 5120 Tₛ | 20480 Tₛ | | |
| 6 | 19760 Tₛ | | | 23040 Tₛ | | |
| 7 | 21952 Tₛ | | | — | — | — |
| 8 | 24144 Tₛ | | | — | — | — |

Where Tₛ represents the minimum time unit in which 1 frame, 10 ms, equals 307,200*Tₛ. The timing represented in Table 2 may correspond to certain symbol lengths. For example, in special subframe configuration 3 having a normal cyclic prefix, the DwPTS will have a length of 24,144*Tₛ, which corresponds to 11 symbols, UpPTS will have a length of 2,192*Tₛ, which corresponds to 1 symbol, and the GP will have a length of approximately 4,384*Ts, which corresponds to 2 symbols.

Changes to the implementation of standards include the possibility of dynamically adapting TDD DL/UL subframe configurations based on the actual traffic needs. If, during a short duration, a large data burst on downlink is needed, a wireless apparatus may change its configuration from, for example, configuration #1 (6 DL:4 UL) to configuration #5 (9 DL:1 UL). See Table 1. The adaptation of TDD configuration is expected to be no slower than 640 ms. In the extreme case, the adaptation may be as fast as 10 ms. Because adjacent cells may operate using different uplink-downlink subframe configurations, the adaptation may cause interference to both downlink and uplink when two or more cells have different overlapping downlink and uplink subframes.

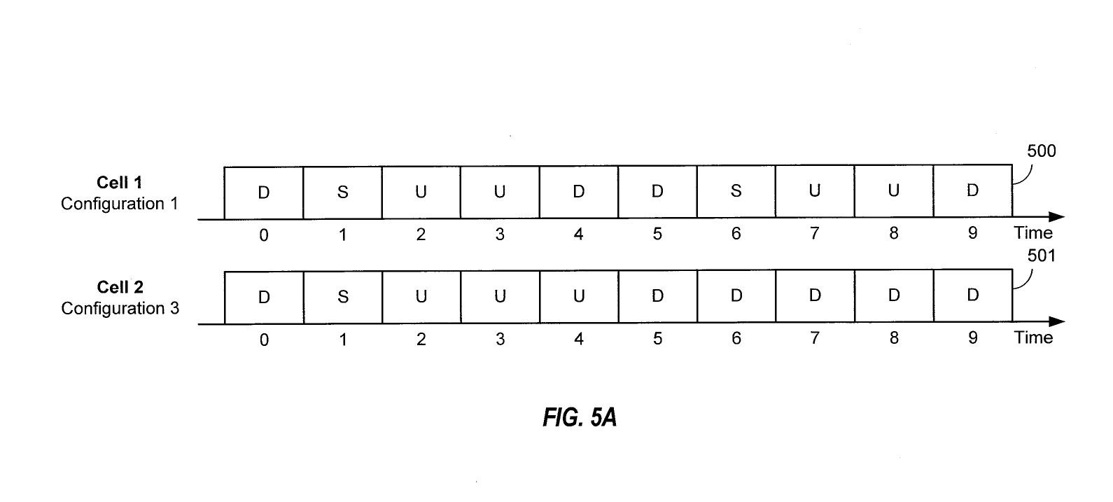

FIG. 5A is a diagram illustrating TDD radio frame transmissions 500 and 501. Radio frame transmission 500 is transmitted from a wireless apparatus within a first cell (cell 1) and is configured according to subframe configuration #1 (Table 1). Radio frame transmission 501 is transmitted from a wireless apparatus with a second cell (cell 2), which may be a neighbor or adjacent cell to cell 1. Radio frame transmission 501 is configured according to subframe configuration #3 (Table 1). Cells 1 and 2 may use the same or different frequencies. Because of the different subframe configurations, strong inter-cell interference may occur (same-frequency or adjacent frequency) in the communication environment. For example, in subframe 4, the downlink transmission for cell 1 may interfere with the uplink transmission for cell 2. Similarly, in subframe 6, the downlink transmission of cell 2 may interfere with the uplink UpPTS of the special subframe of cell 1.

Conventionally, a TDD subframe configuration, once configured, is generally fixed among geographically adjacent cells over a longer duration. In particular, within a 10 ms duration, the two special subframes for the TDD downlink/uplink subframe configurations having 5 ms periodicity (configurations 0, 1, 2, and 6) will have the same special subframe configuration. However, the interference characteristics in the communication environment for different special subframes within the same radio frame may be drastically different. Thus, maintaining the same special subframe configuration can often be inefficient.

Referring back to FIG. 5A, the two cells have DL/UL subframe configurations #1 (cell 1) and #3 (cell 2), respectively. For subframe #1, both cells have the same subframe configuration (special subframe). As a result, the special subframe configuration in subframe #1 may be selected such that a good tradeoff is obtained between DL/UL efficiency and the guard period (GP) that protects DL interference from neighboring cells UL reception. For subframe #6, cell 2 has a downlink subframe and will always interfere with the entire subframe #6 of cell 1 (a special subframe). As a result, no matter how the GP in subframe #6 in cell 1 is configured, the uplink reception in the communication environment of cell 1 will experience strong interference from cell 2 if transmissions are made in the subframe. In this scenario, the two special subframes in the 10 ms duration of cell 1 experience very different interference characteristics. It would, therefore, be beneficial to handle each special subframe differently.

FIG. 5B is a diagram illustrating TDD radio frame transmissions 502 and 503. Cells 1 and 2 start at time, t, with DL/UL subframe configurations #1 and #2, respectively. For subframe #1 and #6, both cells have the same subframe configuration (special subframe). As a result, the special subframe configuration in subframe #1 may be selected for good DL/UL efficiency between cells 1 and 2. The appropriate GP may also be selected for protecting DL interference from neighboring cells UL reception.

For purposes of this example aspect, after a certain duration, at time, t+n, cell 2 changes to subframe configuration #3, while cell 1 remains with subframe configuration 1 (FIG. 5A). Now, the communication environments of the special subframes of subframes #1 and #6 in cell 1 experience different characteristics from what was experienced before cell 2 switched to the new DL/UL subframe configuration. If the original special subframe configuration for subframes #1 and #6 of cell 1 in FIG. 5B, before cell 2 switched configurations, was selected for the best available DL/UL efficiency and appropriate GP to protect against overlap of DL/UL signals, when cell 2 switches configuration, the efficiency of the DL/UL and appropriateness of the GP may be lost on the special subframe of subframe #6.

In existing implementations, when the same subframe configuration is used throughout a cell or among a collection of neighboring cells in a network, basic interference patterns from neighboring cells may be predicted more easily, thus, allowing for the network to select the appropriate special subframe configuration that attempts to result in the best performance characteristics by increasing DL/UL efficiency, protecting against DL/UL overlap, and/or reducing the inter-cell interference experienced by the radio transmissions in the cell. For example, a guard period selected for the known transmission characteristics experienced in the cell would allow a majority of the downlink transmission to fade before the UEs begin transmitting on the uplink. When adjacent cells are capable of dynamically switching TDD configurations, the correlation between the special subframe configurations and the semi-static subframe configurations they were selected to address will be lost at an unpredictable rate. By allowing selective and dynamic adaptation of the special subframe configurations across subframes and over transmission frames and separately or jointly from subframe configuration selection, the effective transmission quality of the special subframe may be preserved or improved.

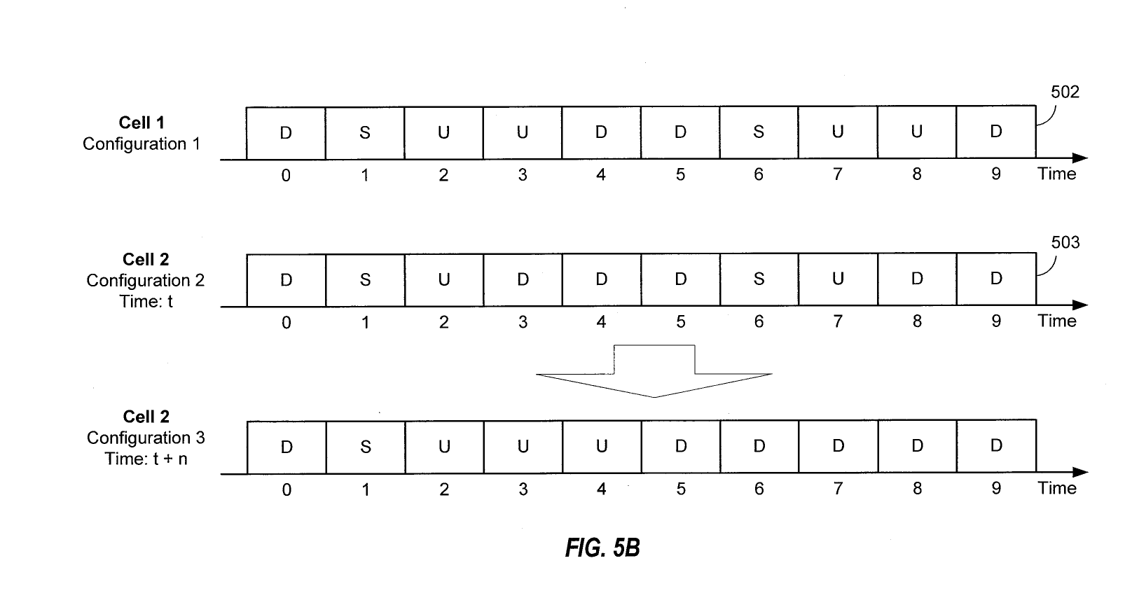

The various aspects of the present disclosure support the ability to use different special subframe configurations within a frame for 5 ms switching periodicity-based TDD DL/UL subframe configurations. FIG. 6A is a diagram illustrating radio frame transmission 500 configured according to one aspect of the present disclosure. Subframe #1 and Subframe #6 are located within the same radio frame and have normal cyclic prefixes. Each includes DwPTS 600 and 603, respectively, GP 601 and 604, respectively, and UpPTS 602 and 605, respectively. Special subframe configuration #0 is selected for subframe #1. As supported in Table 2, special subframe configuration #0 provides that DwPTS 600 includes 3 symbols, GP 601 includes 10 symbols, and UpPTS 602 includes 1 symbol. In subframe #6, special subframe configuration #1 is selected. Special subframe configuration #1 provides that DwPTS 603 includes 9 symbols, GP 604 includes 4 symbols, and UpPTS 605 includes 1 symbol. Special subframe configuration #1 includes less of a guard period which may be more acceptable in subframe #6 than in subframe #1.

Various aspects of the present disclosure may be configured to support different special subframe configurations over different frames for the 5 ms switching periodicity based TDD DL/UL subframe configurations. FIG. 6B is a diagram illustrating radio frame transmission 500 configured according to one aspect of the present disclosure. The portion of radio frame transmission 500 illustrated in FIG. 6B shows multiple frames in the transmission. In frame t, subframes #1 and #6 both use special subframe configuration 2. However, 10 frames later, at frame t+100 ms, subframe #1 uses special subframe configuration 5, while, still within frame t+100 ms, subframe #6 uses special subframe configuration 3. Accordingly, the special subframe configuration may be different, adapted, or updated to a different configuration either within the same frame or across frames.

It should be noted that the adaptation of the special configuration may be triggered by the determined conditions (e.g., inter-cell interference, DL/UL efficiency, DL/UL protection, and the like) of the communication environment experienced within the cell. A UE may assist or request a serving eNB to modify the special configuration based on experienced interference. Additionally or separately, the eNB may make its own determination to change or adapt the special configuration either by analyzing channel quality information received from a UE or by analyzing the its own received signals to determine interference from neighboring cells. Based on the interference analysis, the eNB may select an appropriate special subframe configuration. For example, if the eNB detects interference occurring in the second special subframe of given radio communication with a particular UE and determines that the interference is due to the subframe configuration in the neighboring cell which provides a downlink operation in the corresponding subframe, the serving eNB may select a special subframe configuration for the second special subframes for communications with that UE which reduce the guard period and/or the number of symbols for the UpPTS. Alternatively, the eNB may send a message to the neighboring eNB via a backhaul connection that requests the neighboring eNB to apply a new subframe configuration to the corresponding subframe to reduce the time of the interfering downlink operation. Thus, the serving eNB may analyze the environment of the detected interference and select a special subframe configuration or request a new subframe configuration from one or more neighboring eNBs that may improve the interference, the DL/UL efficiency, or the DL/UL protections.

FIG. 7A is a functional block diagram illustrating example blocks executed to implement one aspect of the present disclosure. At block 700, a first configuration is determined by a UE for use with a first special subframe of a radio transmission in a frame. For example, with reference to FIG. 6A, subframe #1 of radio frame transmission 500 includes a first configuration for the first special subframe. A UE may receive an indication of the various frame configurations used in a cell from the serving cell.

A different configuration is determined, at block 701, for a second subframe in the same frame of the transmission. For example, based on various determining factors, the serving base station may determine to apply a different configuration to a second subframe in the same transmission frame. Accordingly, a UE receives an indication, whether through broadcast or unicast, of the different configuration to apply to the second subframe within the same transmission frame. With reference to subframe #6 of radio frame transmission 500 (FIG. 6A), applying the second configuration results in subframe #6 having special subframe configuration #1 applied. The resulting change of configuration within the same radio frame transmission may improve the performance or reduce the interference experienced in subframe #6 had the same configuration as used in subframe #1 been used.

FIG. 7B is a functional block diagram illustrating example blocks executed to implement one aspect of the present disclosure. At block 702, a serving base station determines a first configuration for a first special subframe of radio transmissions in a particular transmission frame. Again, with reference to FIG. 6A, subframe #1 of radio frame transmission 500 includes a first configuration for the first special subframe. The base station may transmit an indication of the various frame configurations used in a cell to any UEs being served in the cell.

At block 703, the base station detects a difference in the interference level experienced by a second subframe in the same frame with respect to a prior frame. The base station may monitor the interference that each of the UEs within its coverage area may experience from frame to frame. As such, a base station may determine that the second subframe in previous transmission frames has experienced a higher interference than that experienced at the first subframe.

At block 704, the base station determines a different configuration to the second subframe in response to the detected interference difference. The different configuration includes at least a guard period. With the detection of the difference in interference between the first and second subframes, the base station may determine a different configuration to apply to the second subframe in the same frame. The base station would transmit notification of this different configuration to the UEs being served, whether through a broadcast signal or a unicast signal to the specific UE.

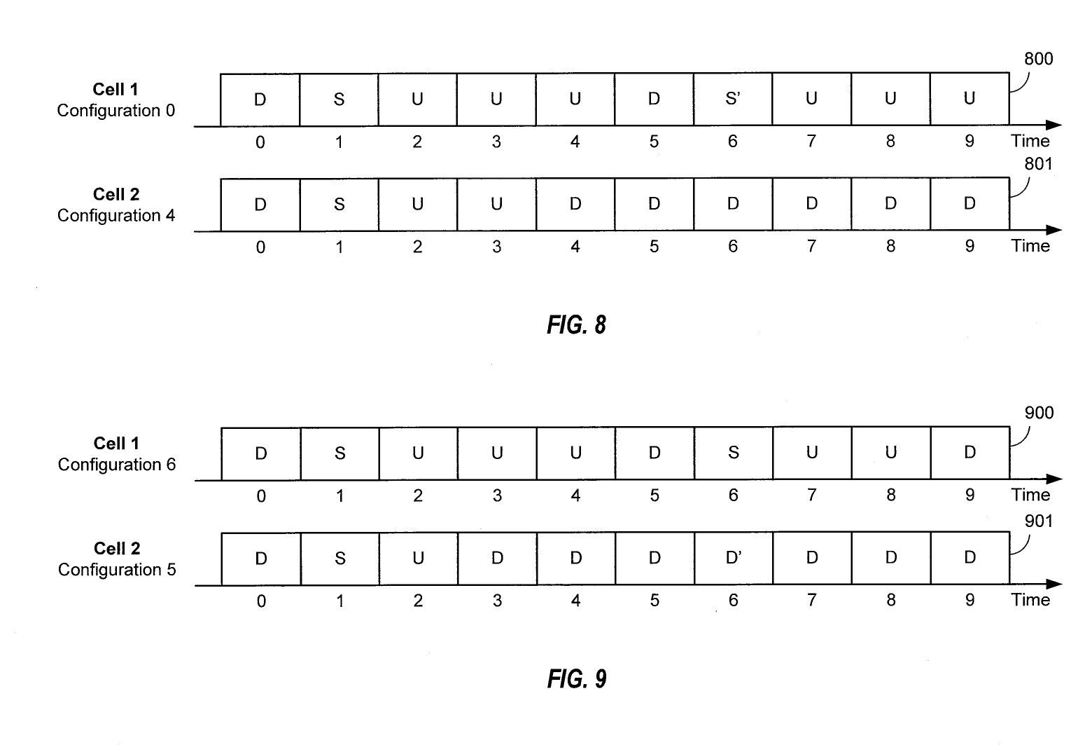

In some aspects, the second configuration may be applied to a regular subframe that is not a special subframe. The interference detected by the base station may relate to the inter-cell interference experienced by the second special subframe or may relate to the DL/UL efficiency or the protection needed for DL/UL transmissions. With reference to FIG. 9, based on a different interference characteristic being experienced by special subframe #6 than that of special subframe #1 of radio frame transmission 900, a special subframe configuration is applied to subframe #6 of radio frame transmission 901.

Over time, the special subframe configuration (regardless of same or different configurations within a frame) may adapt to account for inter-cell interference. This adaptation can be slower than the TDD DL/UL subframe configuration. After detecting the interference, the special subframe configuration may be selected to address the interference level. For example, referring back to FIG. 5B, radio frame transmission 502 of cell 1 detects interference in subframe #6 caused by the special subframe of the corresponding subframe #6 of radio frame transmission 503 in cell 2. New special subframe configurations may then be selected to address such interference. When cell 2 switches from configuration 2 to configuration 3 (FIG. 5A), a downlink subframe in subframe #6 replaces the special subframe of configuration 2 from FIG. 5B. The downlink subframe now causes much more interference in the special subframe of subframe #6 of radio frame transmission 500 from cell 1. New subframe configurations may then be selected to address the increased inter-cell interference from the download operation of the corresponding subframe #6 of radio frame transmission 501. For example, the new subframe configuration may minimize or completely drop the UpPTS section of a special subframe, since the downlink operation in the corresponding subframe in cell 2 would greatly interfere with uplink transmissions in an UpPTS.

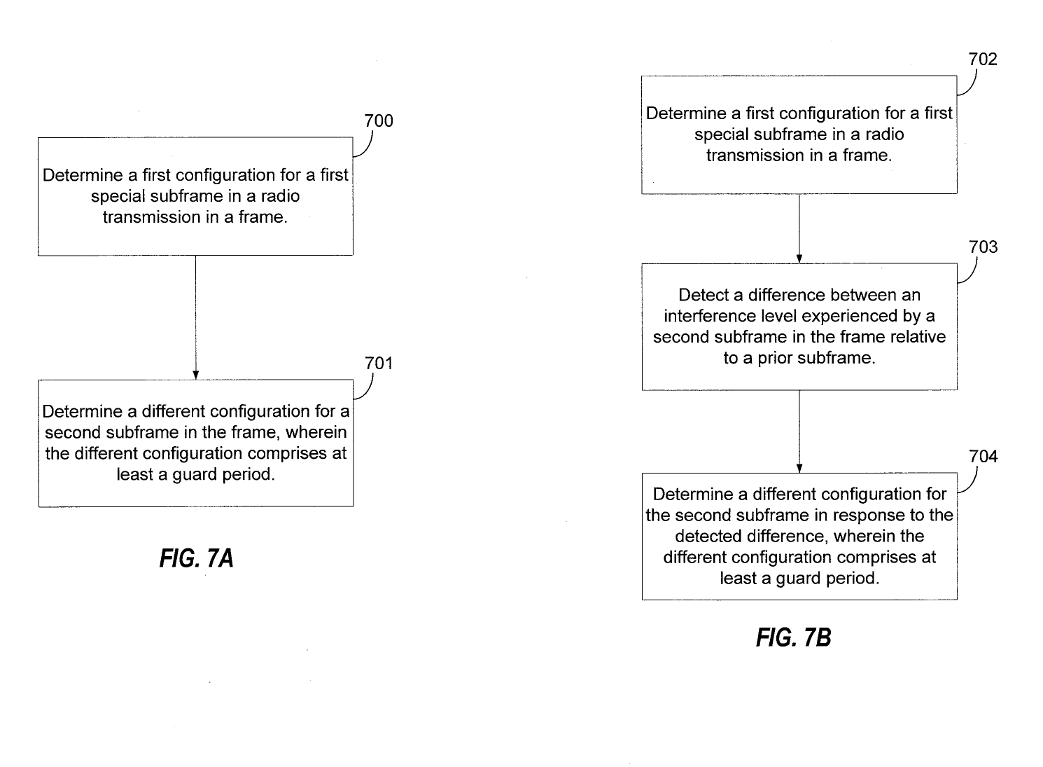

In alternative aspects of the present disclosure, the special subframe configuration applied may wholly modify the subframe. FIG. 8 is a block diagram illustrating radio frame transmissions 800 and 801 configured according to one aspect of the present disclosure. Radio frame transmission 800 of cell 1 is set to subframe configuration #0, while radio frame transmission 801 of cell 2 is set to subframe configuration #4. In subframe #6, the downlink operation of cell 2 will interfere with the UpPTS uplink transmission of the special subframe in corresponding subframe #6 of cell 1. In the present aspect, a new special subframe configuration, S′, is applied to the special subframe #6 of cell 1. Special subframe configuration S′ may configure the subframe without the UpPTS. Because the uplink transmissions in UpPTS may be severely interfered with by the downlink transmission of the corresponding subframe #6 from cell 2, the UpPTS in subframe #6 of cell 1 is unnecessary.

It should be noted that in additional aspects of the present disclosure, any of the parts of the special subframe, DwPTS, GP, and/or UpPTS, may be modified or deleted altogether. However, there may be still a need for a guard period to facilitate the transition from downlink reception to uplink transmission.

FIG. 9 is a block diagram illustrating radio frame transmissions 900 and 901 configured according to one aspect of the present disclosure. Radio frame transmission 900 of cell 1 is set to subframe configuration #6, while radio frame transmission 901 of cell 2 is set to subframe configuration #5. In subframe #6, the downlink operation of cell 2 will interfere with the UpPTS uplink transmission of the special subframe in corresponding subframe #6 of cell 1. In the present aspect, a new special subframe configuration, D′, is applied to the corresponding subframe #6 of cell 2. Special subframe configuration D′ configures the corresponding subframe to shorten the duration of the available downlink transmission operation. By omitting the last one or more symbols from the corresponding subframe #6 in cell 2, the UpPTS uplink transmission is protected in special subframe #6 of cell 1.

The various aspects of the present disclosure provide for dynamically changing the special subframe configurations. In order to accommodate these dynamic changes, signaling may be provided to communicate the selected configuration. The signaling (either explicit or implicit) of the frame and/or subframe-dependent special subframe configuration may be cell-specific or UE-specific. If cell-specific, the signaling may be broadcasted across the cell or via dedicated signaling. For example, with reference to FIG. 1, eNB 110b may broadcast the configurations, such that each of served UEs 120 and 120x receives and decodes the information concerning the specific configurations for macro cell 102b. Alternatively, eNB 110b may directly address this configuration information to each of the UEs 120 and 120x. If UE-specific, the signaling may be transmitted via dedicated signaling. For example, if only UE 120x is to have the referenced special configurations, eNB 110b may specially address notification of the special configuration to UE 120x.

It should be noted that different UEs may have different understanding of the actual special subframe configurations. For instance, if a cell uses special subframe configuration #0 for subframe #1, and special subframe configuration #4 for subframe #6, a first UE (e.g., a legacy UE) may assume and use the same special subframe configuration of #0 for both subframes #1 and #6, while a second UE (e.g., a new UE) may assume and apply the different (and the actual) special subframe configurations to each of the designated special subframes.

In providing signaling of TDD downlink/uplink configuration, one use case is to handle two types of such configurations: (1) the configurations having 5 ms switching periodicity (configurations #0/1/2/6); and (2) the configurations having 10 ms switching periodicity (configurations #3/4/5). As a result, a UE may be configured with two sets of special subframe configurations, and be signaled in a dynamic manner (e.g., via PDCCH) with one-bit to indicate which set is being used for a frame. The one-bit information could, alternatively, be derived implicitly based on the actual TDD downlink/uplink subframe configuration in use, especially if the neighboring cells' TDD subframe configuration is known.

It should be noted that in alternative aspects of the present disclosure, the actual special subframe configurations could be blindly detected by the UE. Blind detection would require both the eNB and the UE to be aligned regarding which special subframe is in use.

The application of dynamic subframe/frame dependent special subframe configuration may have impact on some UL operations. For example, ACK/NAK feedback in response to downlink transmissions, support of physical random access channel (PRACH) format 4 in UpPTS, support of sounding reference signal (SRS) transmissions in UpPTS, etc. To minimize the impact, the update of special subframe configurations may be restricted in some manner. For example, one restriction may be maintaining the duration of the UpPTS regardless of the special subframe configuration update. That is, the update of the special subframe configuration would only, therefore, be limited to the timing between DwPTS and GP.

The ultimate determination of whether ACK/NAK feedback is even necessary for special subframes (e.g., for PUCCH format 3 based ACK/NAK feedback) may be determined on a per UL subframe basis, or on a per frame basis. In selected aspects, this determination may be based on various alternative means. For example, the determination of necessity of ACK/NAK feedback may be based on the special subframe configuration in any of the special subframes. Alternatively, there may be some signaling that can be used to determine ACK/NAK feedback. Additionally, as long as one of the special subframes requires ACK/NAK feedback, ACK/NAK feedback may be determined as necessary for the special subframes. Any number of different means may be used to determine the necessity of such ACK/NAK feedback in special subframes. A UE may even always assume that ACK/NAK feedback is necessary for special subframes as long as the configuration for the special subframes is subject to change.

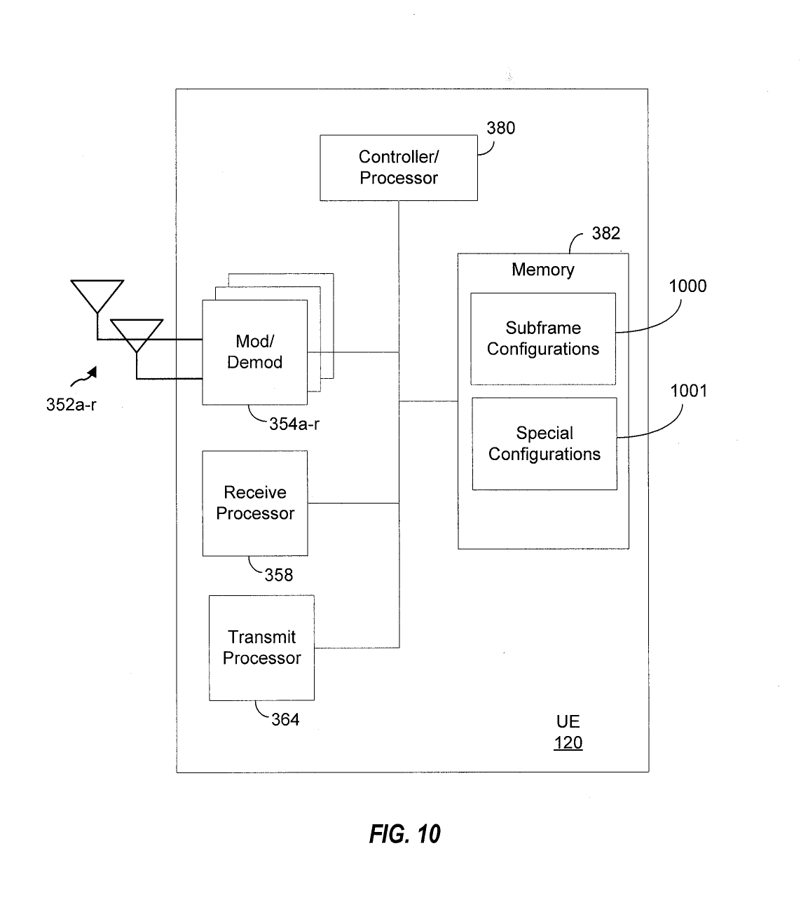

FIG. 10 is a block diagram illustrating a UE 120 configured according to one aspect of the present disclosure. UE 120 includes controller/processor 380 that controls the various components and executes any software or firmware in memory 382 that is used to operate the functionality and features of UE 120. UE 120 receives information from a serving base station with regard to the current configuration applicable to the first special subframe of radio transmissions. Such signals are received by UE 120 over antennas 352a-r, modulator/demodulators 354a-r, and receive processor 358. Under control of controller/processor 380, the signals are decoded to receive the control information for the subframe configuration. Controller/processor 380 accesses memory 382 to determine the specific configuration signaled by the base station. The signal will trigger controller/processor 380 to apply a general subframe configuration from one of the available configurations in subframe configurations table 1000 or a special subframe configuration from one of the available special subframe configurations in special configurations table 1001. With reference to FIG. 6A, for example, UE 120 may determine that special subframe configuration #0 is applied to subframe #1 of radio frame transmission 500. The combination of these components and acts may provide means for determining, by a UE, a first configuration to a first special subframe of a radio transmission in a frame.

Accordingly, UE 120 receives an indication, whether through broadcast or unicast, of the different configuration to apply to the second subframe within the same transmission frame. UE 120 will receive this indication over antennas 352a-r, modulator/demodulators 354a-r, and receive processor 358. Under control of controller/processor 380, the signals are decoded to receive the control information for the subframe configuration. With reference to subframe #6 of radio frame transmission 500 (FIG. 6A), applying the second configuration results in subframe #6 having special subframe configuration #1 applied. The combination of these components and acts may provide means for determining, by the UE, a second configuration to a second subframe in the frame, wherein the first configuration is different than the second configuration and the second configuration comprises at least a guard period.

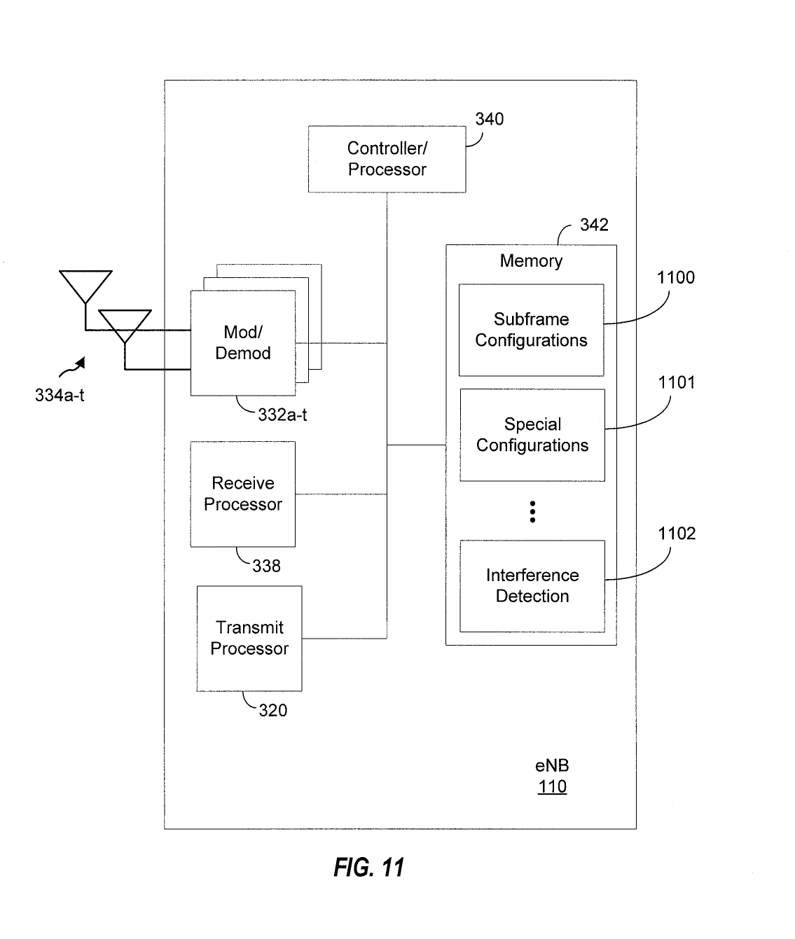

FIG. 11 is a block diagram illustrating an eBN 110 configured according to one aspect of the present disclosure. The eNB 110 includes controller/processor 340 that controls the various components and executes any software or firmware in memory 342 that is used to operate the functionality and features of eNB 110. Under control of controller/processor 340, eNB 110 determines which subframe configuration and special subframe configurations to apply to the cell transmission frames. The configurations are accessed in memory 342 in subframe configurations table 1100 and special configurations table 1101. Using transmit processor 320, modulator/demodulators 332a-t, and antennas 334a-t, eNB 110, under control of controller/processor 340 signals the selected configuration to one or more mobile devices within the cell coverage area. The combination of these components and acts may provide means for applying, at a base station, a first configuration to a first special subframe of a radio transmission in a frame.

eNB 110, under control of controller/processor 340, may execute interference detection logic 1102, stored in memory 342, in order to detect interference on such a second subframe within the same frame. Interference may be detected based on signals received at eNB 110 over antennas 334a-t, modulatory/demodulators 332a-t, and receive processor 338. The combination of these components and acts may provide means for detecting, by the base station, a difference between an interference level experienced by a second subframe in the frame with respect to the first special subframe.

When the interference change has been detected, eNB 110, under control of controller/processor 340, access memory 342 to select a different configuration, from one or both of subframe configurations table 110 or special configurations table 1101. The selection is generally made by eNB 110 to improve the interference condition, improve DL/UL efficiency, or some combination thereof. The newly selected configuration is transmitted using transmit processor 320, modulator/demodulators 332a-t, and antennas 334a-t, under control of controller/processor 340. The combination of these components and acts may provide means for applying, by the base station, a second configuration to the second subframe in response to the detected difference, wherein the first configuration is different than the second configuration and the second configuration comprises at least a guard period.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 7A and 7B may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
determining, by a user equipment (UE), a first configuration for a first special subframe in a radio transmission in a frame; and
determining, by the UE, a second configuration for a second subframe in the frame, wherein the first configuration is different than the second configuration and the second configuration comprises at least a guard period (GP).

2. The method of claim 1, wherein the second subframe comprises a special subframe.

3. The method of claim 1, wherein the second subframe comprises a downlink subframe.

4. The method of claim 1, wherein the second configuration preserves a same Uplink Pilot Time Slot (UpPTS) duration as the first configuration.

5. The method of claim 1, further comprising:
determining, on a per frame basis, whether acknowledgement/non-acknowledgement (ACK/NAK) feedback is used for the first special subframes or the second subframe or both.

6. The method of claim 5, wherein the determining is based on one or more of:
the first configuration of the first special subframe;
the second configuration of the second subframe; or
a combination thereof.

7. The method of claim 1, wherein the second configuration makes the subframe a special subframe by omitting a Downlink Pilot Time Slot (DwPTS) or a UpPTS.

8. The method of claim 1, further comprising:
receiving a broadcast message identifying the first and second configurations used for the radio transmission in a cell.

9. The method of claim 8, wherein the broadcast message comprises a coded indication identifying which of two or more sets of configurations include the first configuration and the second configuration.

10. The method of claim 1, further comprising:
receiving a unicast message identifying the first configuration and second configurations.

11. A method of wireless communication, comprising:
determining, at a base station, a first configuration for a first special subframe in a radio transmission in a frame;
detecting, by the base station, a difference between an interference level experienced by a second subframe in the frame relative to a prior frame; and
detecting, by the base station, a second configuration for the second subframe in response to the detected difference, wherein the first configuration is different than the second configuration and the second configuration comprises at least a guard period (GP).

12. The method of claim 11, wherein the second subframe comprises a special subframe.

13. The method of claim 11, wherein the second subframe comprises a downlink subframe.

14. The method of claim 11, wherein the second configuration preserves a same Uplink Pilot Time Slot (UpPTS) duration as the first configuration.

15. The method of claim 11, further comprising:
determining, on a per frame basis, whether acknowledgement/non-acknowledgement (ACK/NAK) feedback is used for one or more of the first special subframe and the second subframe.

16. The method of claim 15, wherein the determining is based on one or more of:
the first configuration;
the second configuration; or
a combination thereof.

17. The method of claim 11, wherein the second configuration makes the subframe a special subframe by omitting a Downlink Pilot Time Slot (DwPTS) or a UpPTS.

18. The method of claim 11, further comprising:
signaling the second configuration to a neighboring base station;
wherein the second subframe is a subframe transmitted by a neighboring base station, and the time duration of the second subframe overlaps a corresponding subframe of the base station.

19. The method of claim 18, wherein the second configuration shortens an operation duration of the second subframe in the neighboring cell, wherein the operation comprises one of: an uplink or a downlink operation.

20. The method of claim 18, wherein the neighboring cell is of a same carrier frequency.

21. The method of claim 18, wherein the neighboring cell is of a different carrier frequency than the base station.

22. The method of claim 11, wherein the detecting the difference in the interference level comprises:
detecting inter-cell interference from one or more neighboring cells.

23. The method of claim 11, further comprising:
updating one or more of the first and second configurations in response to the detected inter-cell interference.

24. The method of claim 11, further comprising:
broadcasting identification of the first and second configurations used for the radio transmission in a cell.

25. The method of claim 24, wherein the identification is a coded indication identifying which of two or more sets of configuration include the first configuration and the second configuration.

26. The method of claim 11, further comprising:
transmitting an identification of the first and second configurations to a user equipment using the radio transmission for communication.

27. The method of claim 11, wherein the communication environment comprises one or more of:
inter-cell interference;
downlink (DL)/uplink (UL) efficiency;
DL/UL protection; or
a combination thereof.

28. An apparatus configured for wireless communication, comprising:
means for determining, by a user equipment (UE), a first configuration for a first special subframe in a radio transmission in a frame; and
means for determining, by the UE, a second configuration for a second subframe in the frame, wherein the first configuration is different than the second configuration and the second configuration comprises at least a guard period (GP).

29. The apparatus of claim 28, wherein the second subframe comprises a special subframe.

30. The apparatus of claim 28, wherein the second subframe comprises a downlink subframe.

31. The apparatus of claim 28, wherein the second configuration preserves a same Uplink Pilot Time Slot (UpPTS) duration as the first configuration.

32. The apparatus of claim 28, further comprising:
means for determining, on a per frame basis, whether acknowledgement/non-acknowledgement (ACK/NAK) feedback is used for the first special subframes or the second subframe or both.

33. The apparatus of claim 32, wherein the means for determining is based on one or more of:
the first configuration of the first special subframe;
the second configuration of the second subframe; or
a combination thereof.

34. The apparatus of claim 28, wherein the second configuration makes the subframe a special subframe by omitting a Downlink Pilot Time Slot (DwPTS) or a UpPTS.

35. The apparatus of claim 28, further comprising:
means for receiving a broadcast message identifying the first and second configurations used for the radio transmission in a cell.

36. The apparatus of claim 35, wherein the broadcast message comprises a coded indication identifying which of two or more sets of configurations include the first configuration and the second configuration.

37. The apparatus of claim 28, further comprising:
means for receiving a unicast message identifying the first configuration and second configurations.

38. An apparatus configured for wireless communication, comprising:
means for determining, at a base station, a first configuration for a first special subframe in a radio transmission in a frame;
means for detecting, by the base station, a difference between an interference level experienced by a second subframe in the frame relative to a prior frame; and
means for detecting, by the base station, a second configuration for the second subframe in response to the detected difference, wherein the first configuration is different than the second configuration and the second configuration comprises at least a guard period (GP).

39. The apparatus of claim 38, wherein the second subframe comprises a special subframe.

40. The apparatus of claim 38, wherein the second subframe comprises a downlink subframe.

41. The apparatus of claim 38, wherein the second configuration preserves a same Uplink Pilot Time Slot (UpPTS) duration as the first configuration.

42. The apparatus of claim 38, further comprising:
means for determining, on a per frame basis, whether acknowledgement/non-acknowledgement (ACK/NAK) feedback is used for one or more of the first special subframe and the second subframe.

43. The apparatus of claim 42, wherein the means for determining is based on one or more of:
the first configuration;
the second configuration; or
a combination thereof.

44. The apparatus of claim 38, wherein the second configuration makes the subframe a special subframe by omitting a Downlink Pilot Time Slot (DwPTS) or a UpPTS.

45. The apparatus of claim 38, further comprising:
means for signaling the second configuration to a neighboring base station;
wherein the second subframe is a subframe transmitted by a neighboring base station, and the time duration of the second subframe overlaps a corresponding subframe of the base station.

46. The apparatus of claim 45, wherein the second configuration shortens an operation duration of the second subframe in the neighboring cell, wherein the operation comprises one of: an uplink or a downlink operation.

47. The apparatus of claim 45, wherein the neighboring cell is of a same carrier frequency.

48. The apparatus of claim 45, wherein the neighboring cell is of a different carrier frequency than the base station.

49. The apparatus of claim 38, wherein the means for detecting the difference in the interference level comprises:
means for detecting inter-cell interference from one or more neighboring cells.

50. The apparatus of claim 38, further comprising:
means for updating one or more of the first and second configurations in response to the detected inter-cell interference.

51. The apparatus of claim 38, further comprising:
means for broadcasting identification of the first and second configurations used for the radio transmission in a cell.

52. The apparatus of claim 51, wherein the identification is a coded indication identifying which of two or more sets of configuration include the first configuration and the second configuration.

53. The apparatus of claim 38, further comprising:
means for transmitting an identification of the first and second configurations to a user equipment using the radio transmission for communication.

54. The apparatus of claim 38, wherein the communication environment comprises one or more of:
inter-cell interference;
downlink (DL)/uplink (UL) efficiency;
DL/UL protection; or
a combination thereof.

55. A computer program product for wireless communications in a wireless network, comprising:
a non-transitory computer-readable medium having program code recorded thereon, the program code including:
program code for causing a computer to determine, by a user equipment (UE), a first configuration for a first special subframe in a radio transmission in a frame; and
program code for causing a computer to determine, by the UE, a second configuration for a second subframe in the frame, wherein the first configuration is different than the second configuration and the second configuration comprises at least a guard period (GP).

56. The computer program product of claim 55, wherein the second subframe comprises a special subframe.

57. The computer program product of claim 55, wherein the second subframe comprises a downlink subframe.

58. The computer program product of claim 55, wherein the second configuration preserves a same Uplink Pilot Time Slot (UpPTS) duration as the first configuration.

59. The computer program product of claim 55, further comprising:
program code for causing a computer to determine, on a per frame basis, whether acknowledgement/non-acknowledgement (ACK/NAK) feedback is used for the first special subframes or the second subframe or both.

60. The computer program product of claim 55, further comprising:
program code for causing a computer to receive a broadcast message identifying the first and second configurations used for the radio transmission in a cell.

61. The computer program product of claim 55, further comprising:
program code for causing a computer to receive a unicast message identifying the first configuration and second configurations.

62. A computer program product for wireless communications in a wireless network, comprising:
a non-transitory computer-readable medium having program code recorded thereon, the program code including:
program code for causing a computer to determine, at a base station, a first configuration for a first special subframe in a radio transmission in a frame;
program code for causing a computer to detect, by the base station, a difference between an interference level experienced by a second subframe in the frame relative to a prior frame; and
program code for causing a computer to detect, by the base station, a second configuration for the second subframe in response to the detected difference, wherein the first configuration is different than the second configuration and the second configuration comprises at least a guard period (GP).

63. The computer program product of claim 62, wherein the second subframe comprises a special subframe.

64. The computer program product of claim 62, wherein the second subframe comprises a downlink subframe.

65. The computer program product of claim 62, wherein the second configuration preserves a same Uplink Pilot Time Slot (UpPTS) duration as the first configuration.

66. The computer program product of claim 62, further comprising:
program code for causing a computer to determine, on a per frame basis, whether acknowledgement/non-acknowledgement (ACK/NAK) feedback is used for one or more of the first special subframe and the second subframe.

67. The computer program product of claim 62, further comprising:
program code for causing a computer to signal the second configuration to a neighboring base station;
wherein the second subframe is a subframe transmitted by a neighboring base station, and the time duration of the second subframe overlaps a corresponding subframe of the base station.

68. The computer program product of claim 67, wherein the second configuration shortens an operation duration of the second subframe in the neighboring cell, wherein the operation comprises one of: an uplink or a downlink operation.

69. The computer program product of claim 62, wherein the program code for causing a computer to detect the difference in the interference level comprises:
program code for causing a computer to detect inter-cell interference from one or more neighboring cells.

70. The computer program product of claim 62, further comprising:
program code for causing a computer to update one or more of the first and second configurations in response to the detected inter-cell interference.

71. The computer program product of claim 62, further comprising:
program code for causing a computer to broadcast identification of the first and second configurations used for the radio transmission in a cell.

72. The computer program product of claim 62, wherein the communication environment comprises one or more of:
inter-cell interference;
downlink (DL)/uplink (UL) efficiency;
DL/UL protection; or
a combination thereof.

73. An apparatus configured for wireless communication, the apparatus comprising:
at least one processor; and
a memory coupled to the at least one processor,
wherein the at least one processor is configured:
to determine, by a user equipment (UE), a first configuration for a first special subframe in a radio transmission in a frame; and
to determine, by the UE, a second configuration for a second subframe in the frame, wherein the first configuration is different than the second configuration and the second configuration comprises at least a guard period (GP).

74. The apparatus of claim 73, wherein the second subframe comprises a special subframe.

75. The apparatus of claim 73, wherein the second subframe comprises a downlink subframe.

76. The apparatus of claim 73, wherein the second configuration preserves a same Uplink Pilot Time Slot (UpPTS) duration as the first configuration.

77. The apparatus of claim 73, wherein the at least one processor is further configured:
to determine, on a per frame basis, whether acknowledgement/non-acknowledgement (ACK/NAK) feedback is used for the first special subframes or the second subframe or both.

78. The apparatus of claim 73, wherein the at least one processor is further configured:
to receive a broadcast message identifying the first and second configurations used for the radio transmission in a cell.

79. The apparatus of claim 73, wherein the at least one processor is further configured:
to receive a unicast message identifying the first configuration and second configurations.

80. An apparatus configured for wireless communication, the apparatus comprising:
at least one processor; and
a memory coupled to the at least one processor,
wherein the at least one processor is configured:
to determine, at a base station, a first configuration for a first special subframe in a radio transmission in a frame;
to detect, by the base station, a difference between an interference level experienced by a second subframe in the frame relative to a prior frame; and
to detect, by the base station, a second configuration for the second subframe in response to the detected difference, wherein the first configuration is different than the second configuration and the second configuration comprises at least a guard period (GP).

81. The apparatus of claim 80, wherein the second subframe comprises a special subframe.

82. The apparatus of claim 80, wherein the second subframe comprises a downlink subframe.

83. The apparatus of claim 80, wherein the second configuration preserves a same Uplink Pilot Time Slot (UpPTS) duration as the first configuration.

84. The apparatus of claim 80, wherein the at least one processor is further configured:
to determine, on a per frame basis, whether acknowledgement/non-acknowledgement (ACK/NAK) feedback is used for one or more of the first special subframe and the second subframe.

85. The apparatus of claim 80, wherein the at least one processor is further configured:
to signal the second configuration to a neighboring base station;
wherein the second subframe is a subframe transmitted by a neighboring base station, and the time duration of the second subframe overlaps a corresponding subframe of the base station.

86. The apparatus of claim 85, wherein the second configuration shortens an operation duration of the second subframe in the neighboring cell, wherein the operation comprises one of: an uplink or a downlink operation.

87. The apparatus of claim 80, wherein the configuration of the at least one processor to detect the difference in the interference level comprises configuration:
to detect inter-cell interference from one or more neighboring cells.

88. The apparatus of claim 80, wherein the at least one processor is further configured:
to update one or more of the first and second configurations in response to the detected inter-cell interference.

89. The apparatus of claim 80, wherein the at least one processor is further configured:
to broadcast identification of the first and second configurations used for the radio transmission in a cell.

90. The apparatus of claim 80, wherein the communication environment comprises one or more of:
inter-cell interference;
downlink (DL)/uplink (UL) efficiency;
DL/UL protection; or
a combination thereof.
